(19) United States
(12) Patent Application Publication
(10) Pub. No.: US 2005/0046778 A1
(43) Pub. Date: Mar. 3, 2005

(54) Liquid crystal display panel with dual sealing and method for fabricating the same

(76) Inventors: Kun-Hsing Hsiao, Miao-Li (TW); Jia-Pang Pang, Miao-Li (TW)

Correspondence Address: WEI TE CHUNG;FOXCONN INTERNATIONAL, INC., 1650 MEMOREX DRIVE, SANTA CLARA, CA, 95050, US

(21) Appl. No.: 10/930,136

(22) Filed: Aug. 30, 2004

(30) Foreign Application Priority Data
Aug. 29, 2003 (TW) 92123947

(51) Int. Cl. G02F 1/1339

(52) U.S. Cl. 349/153

(57) ABSTRACT

A liquid crystal display panel (10) includes a first substrate (11), a second substrate (13), a first seal pattern (111), a liquid crystal layer (15), and a second seal pattern (113). The second substrate is spaced apart from the first substrate. The first seal pattern interconnects the first substrate and the second substrate, and defines a cell area therebetween. The liquid crystal layer is accommodated in the cell area. The second seal pattern encloses the first seal pattern, and is spaced a distance (D) therefrom. Each of the first and second seal patterns is a continuous body. The liquid crystal display panel has the first substrate and the second substrate securely combined together by use of the dual seal patterns. The space between the first seal pattern and the second seal pattern can be a vacuum. The vacuum can strengthen the combination of the first substrate with the second substrate.

### BACKGROUND OF THE INVENTION

1. Field of the Invention

The present invention relates to a liquid crystal display (LCD) panel and a method for fabricating the same, and especially to an LCD panel having substrates thereof strongly combined together.

2. Description of Prior Art

An LCD panel generally comprises two glass substrates, a peripheral seal pattern, and a plurality of liquid crystal molecules retained between the substrates. The seal pattern is printed on one of the glass substrates, and is adhered to the other glass substrate. The substrates and the seal pattern cooperatively form a space therebetween, with the liquid crystal molecules being filled in the space.

There are generally two methods used for filling the liquid crystal molecules into the space. The first method is to fill the liquid crystal molecules through filling ports. This method comprises the following steps: firstly, printing a seal pattern on a first glass substrate, wherein the seal pattern is quadrate and has one or more gaps that function as filling ports; secondly, combining a second glass substrate with the first glass substrate and curing the seal pattern, wherein a space is enclosed by the seal pattern and the two glass substrates; thirdly, immersing the filling ports in a liquid crystal in a vacuum chamber; and finally, introducing gas into the vacuum chamber to make the liquid crystal molecules fill up the space.

The second method is the so-called one-drop-fill (ODF) method. This method comprises the following steps: firstly, printing a seal pattern on a first glass substrate, wherein the seal pattern is quadrate and continuous, and a space is enclosed by the seal pattern and the first glass substrate; secondly, putting liquid crystal molecules into the space drop by drop using a dispenser; and finally, combining a second glass substrate with the first glass substrate and curing the seal pattern.

When the glass substrates are combined in the ODF method, a distance separating the glass substrates must be highly precise. In practice, it is difficult to achieve the high level of precision desired.

Referring to FIG. 5, this shows an LCD panel as disclosed in U.S. Pat. No. 6,222,603. The LCD panel comprises a first substrate 2, a seal pattern 6 printed on the first substrate 2, a liquid crystal layer (not shown) filled into a space enclosed by the seal pattern 6 and the first substrate 2, and a second substrate (not shown) combined with the first substrate 2. Each of the first substrate 2 and the second substrate has an alignment film 7.

A method for producing said LCD panel comprises the following steps: firstly, forming the seal pattern 6 on the first substrate 2 to define the space for accommodating the liquid crystal layer; secondly, forming a dummy seal pattern 8 on the first substrate 2 completely enclosing the seal pattern 6, wherein a distance between the seal pattern 6 and the dummy seal pattern 8 is in the range from about 10 to 15 mm; thirdly, distributing spacers on the first substrate 2, the spacers having a predetermined size for supporting the first substrate 2 and the second substrate and forming a gap between the first substrate 2 and the second substrate; fourthly, aligning and combining together the first substrate 2 and the second substrate in a vacuum chamber; at finally, curing the seal pattern 6 and removing the dummy seal pattern 8.

Because the dummy seal pattern 8 is used during fabrication, a highly uniform gap between the first substrate 2 and second substrate can be obtained.

However, said LCD panel still has some drawbacks. Because the dummy seal pattern 8 is removed after the seal pattern 6 is cured, the two substrates are held together by the single seal pattern 6 only. In addition, because the seal pattern 6 is exposed to the external environment, it is liable to become weathered or contaminated. The seal pattern 6 may become deteriorated or damaged, thereby reducing the reliability and service lifetime of the LCD panel.

Thus, a new LCD panel and a method for fabricating the same that overcome the above-mentioned disadvantages are desired.

### SUMMARY OF THE INVENTION

An object of the present invention is to provide a liquid crystal display panel having substrates thereof strongly combined together.

Another object of the present invention is to provide a method for fabricating the above-described liquid crystal display panel.

In order to achieve the first object set out above, a liquid crystal display panel in accordance with the present invention comprises a first substrate, a second substrate, a first seal member, a liquid crystal layer and a second seal member. The second substrate is spaced apart from the first substrate. The first seal member interconnects the first substrate and the second substrate, and defines a cell area therebetween. The liquid crystal layer is accommodated in the cell area. The second seal member encloses the first seal member, and is spaced a distance from the first seal member.

In order to achieve the second object set out above, a method for fabricating a liquid crystal display panel comprises: forming a first seal member on a first substrate, thereby defining a space for accommodating a liquid crystal layer; forming a second seal member on the first substrate or on a second substrate, the second seal member being configured to enclose the first seal member and being spaced a distance therefrom; filling a liquid crystal layer into the space; combining the first substrate and the second substrate together; and curing the first seal member and the second seal member.

The liquid crystal layer panel and the fabricating method of the present invention can enhance the combination of the first substrate and the second substrate by using the double seal members.

Other objects, advantages, and novel features of the present invention will become more apparent from the following detailed description when taken in conjunction with the accompanying drawings, in which:

### BRIEF DESCRIPTION OF THE DRAWINGS

FIG. 1 is an exploded, isometric view of an LCD panel according to a first embodiment of the present invention;

FIG. 2 is a schematic, cross-sectional view of part of the LCD panel of FIG. 1 fully assembled;

FIG. 3 is an exploded, isometric view of an LCD panel according to a second embodiment of the present invention;

FIG. 4 is a flow chart of a method for fabricating the LCD panel according to the present invention; and

FIG. 5 is a schematic, cross-sectional view of a conventional LCD panel, showing seal patterns on a first substrate thereof.

### DETAILED DESCRIPTION OF THE INVENTION

Reference will now be made to the drawings to describe the present invention in detail.

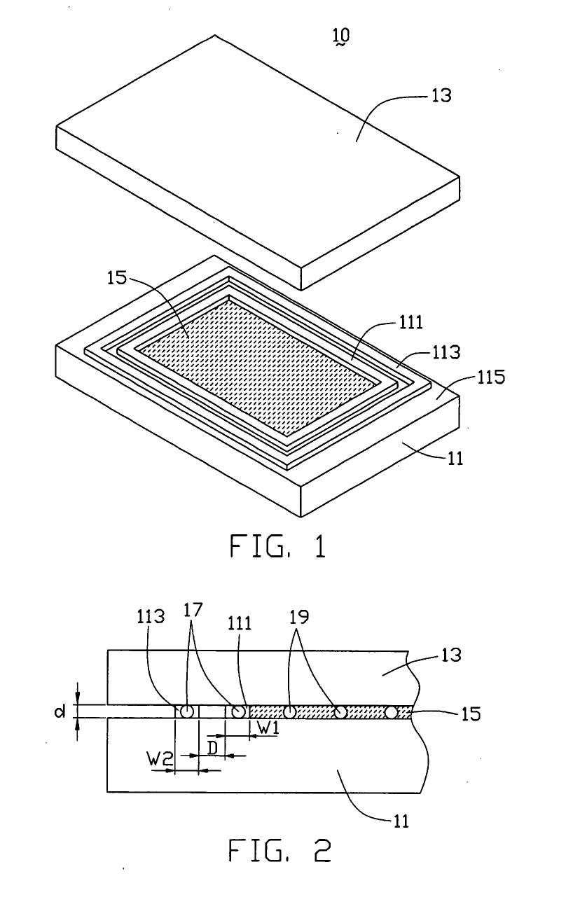

Referring to FIG. 1 and FIG. 2, an LCD panel 10 in accordance with a first embodiment of the present invention comprises a first substrate 11, a second substrate 13 spaced apart from the first substrate 11, a first seal pattern 111, a second seal pattern 113, and a liquid crystal layer 15 interposed between the first substrate 11 and the second substrate 13. The first substrate 11 is a thin film transistor (TFT) substrate, and the second substrate 13 is a color filter substrate. The first substrate 11 has an inner surface 115.

The first seal pattern 111 and the second seal pattern 113 are provided between the first and second substrates 11, 13 to seal the first and the second substrates 11, 13 together. Each of the first and second seal patterns 111, 113 is a continuous body, with the second seal pattern 113 enclosing the first seal pattern 111. A uniform distance D between the first seal pattern 111 and the second seal pattern 113 is in the range from about 10 mm to about 50 mm. The first seal pattern 111 and the second seal pattern 113 are made of a same material, such as an ultraviolet cured sealing material or a thermosetting sealing material. Furthermore, spacers 17 are integrated in the first seal pattern 111 and the second seal pattern 113, to enhance the hardness thereof. The spacers 17 are columnar glass fibers. A proportion of the spacers 17 to the seal patterns 111, 113 is in the range from about 0.5 wt % to about 2 wt %.

In assembly, the first substrate 11 and the second substrate 13 are combined together by the first and the second seal patterns 111, 113. The first seal pattern 111, the first substrate 11 and the second substrate 13 cooperatively define a cell area (not labeled) therebetween, in which the liquid crystal layer 15 is accommodated. In addition, a plurality of spacers 19 is distributed in the liquid crystal layer 15. The hardness of the seal patterns 111, 113 helps ensure that a uniform gap d is maintained between the first substrate 11 and the second substrate 13.

As described above, the LCD panel 10 of present invention has the first substrate 11 and the second substrate 13 securely combined together by use of the dual seal patterns 111, 113. In addition, because each of the seal patterns 111, 113 is a continuous body, the space between the first seal pattern 111 and the second seal pattern 113 can be a vacuum. The vacuum can strengthen the combination of the first substrate 11 with the second substrate 13.

Furthermore, because the seal patterns 111, 113 are made of the same material, the gap d between the first substrate 11 and the second substrate 13 is uniform. Moreover, the second seal pattern 113 protects the first seal pattern 111 and the liquid crystal layer 15 from weathering and external contaminants. That is, the double layered seal pattern configuration reduces the risk of deterioration of the liquid crystal layer 15, and improves the reliability and working lifetime of the LCD panel 10.

In alternative embodiments, a width W1 of the first seal pattern 111 and a width W2 of the second seal pattern 113 can be increased in order to achieve an even stronger combination of the first and second substrates 11, 13. The first seal pattern 111 and the second seal pattern 113 can be made of a material having both ultraviolet curing characteristics and thermosetting characteristics. The glass spacers 17 can instead be replaced by spherical silicate spacers, which can provide even more uniform spacing between the first and second substrates 11, 13.

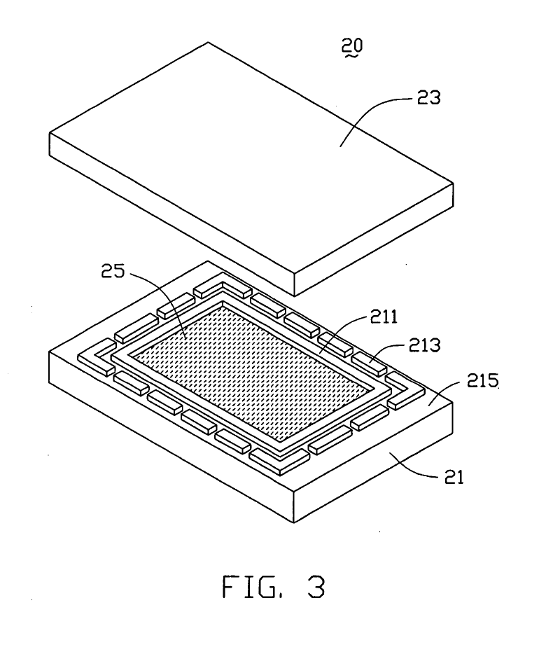

Referring to FIG. 3, an LCD panel 20 in accordance with a second embodiment of the present invention comprises a first substrate 21 with an inner surface 215, a second substrate 23, a first seal pattern 211, a second seal pattern 213, and a liquid crystal layer 25. The difference between the LCD panel 20 and the LCD panel 10 is that the second seal pattern 213 is a discontinuous body. The LCD panel 20 has the first substrate 21 and the second substrate 23 securely combined together by use of the dual seal patterns 211, 213.

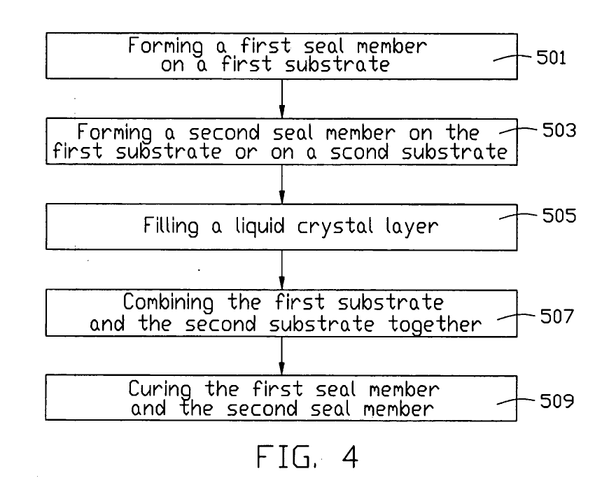

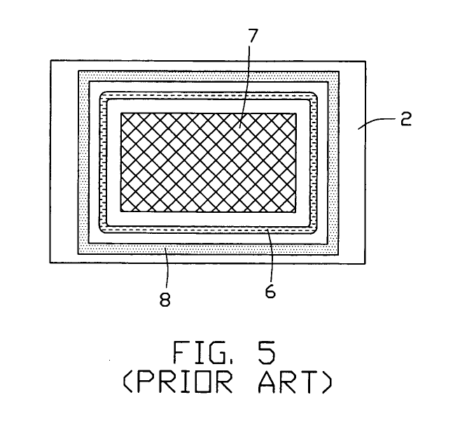

FIG. 4 is a flow chart of a method for fabricating the LCD panel 10 according to the present invention. The method is equally applicable for fabricating the LCD panel 20. Details of the method are as follows:

In step 501, the first seal pattern 111 is printed on the inner surface 115 of the first substrate 11 to define the cell area for accommodating the liquid crystal layer 15. Alternatively, the first seal pattern 111 can be formed on the inner surface 115 by way of a deposition process. Spacers 17 are incorporated in the first seal pattern 111, to enhance the hardness thereof. The spacers 17 are columnar glass fibers, and a proportion of the spacers 17 to the first seal pattern 111 is in the range from about 0.5 wt % to about 2 wt %.

In step 503, the second seal pattern 113 having the same material as the first seal pattern 111 is printed on the inner surface 115 of the first substrate 11 or on the second substrate 13. The second seal pattern 113 is configured to enclose the first seal pattern 111. The distance D between the first seal pattern 111 and the second seal pattern 113 is between about 10 mm and about 50 mm.

In step 505, the liquid crystal layer 15 is filled into the cell area by the one-drop-fill method, and the spacers 19 are distributed in the liquid crystal layer 15. Alternatively, before step 501, a photo resist layer can be deposited on the inner surface 115 of the first substrate 11 or on the second substrate 13. The photo resist layer is then exposed and developed to form the spacers 19.

In step 507, the first substrate 11 and the second substrate 13 are combined together under vacuum. This ensures that the gap d between the first substrate 11 and the second substrate 13 is uniform.

In step 509, the first seal pattern 111 and the second seal pattern 113 are cured by ultraviolet radiation. The cured seal patterns 111, 113 firmly adhere the first substrate 11 and the second substrate 13 together. Alternatively, if the first seal pattern 111 and the second seal pattern 113 are made of a thermosetting sealing material, then the seal patterns 111, 113 are cured by heating.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

1. An LCD (liquid crystal display) panel, comprising:
a first substrate;
a second substrate spaced apart from the first substrate;
a first seal member interconnecting the first substrate and the second substrate, and defining a cell area therebetween;
a liquid crystal layer accommodated in the cell area; and
a second seal member enclosing the first seal member, and spaced a distance from the first seal member.

2. The LCD panel as recited in claim 1, wherein the first seal member and the second seal member both comprise a same material selected from the group consisting of an ultraviolet cured sealing material, a thermosetting sealing material, and a combined ultraviolet and thermosetting sealing material.

3. The LCD panel as recited in claim 1, wherein spacers are incorporated in the first seal member and the second seal member.

4. The LCD panel as recited in claim 3, wherein the spacers are columnar glass fibers or spherical silicate spacers.

5. The LCD panel as recited in claim 3, wherein a proportion of the spacers to the first and second seal members is in the range from 0.5 wt % to 2 wt %.

6. The LCD panel as recited in claim 1, wherein a distance between the first seal member and the second seal member is in the range from 10 mm to 50 mm.

7. The LCD panel as recited in claim 1, further comprising a plurality of spacers distributed in the liquid crystal layer.

8. The LCD panel as recited in claim 7, wherein the spacers are formed on a surface of the first substrate facing the second substrate.

9. The LCD panel as recited in claim 7, wherein the spacers are formed on a surface of the second substrate facing the first substrate.

10. The LCD panel as recited in claim 7, wherein the spacers are columnar or spherical.

11. The LCD panel as recited in claim 1, wherein the second seal member is a continuous body.

12. The LCD panel as recited in claim 11, wherein a vacuum is formed between the first seal member and the second seal member.

13. The LCD panel as recited in claim 1, wherein the second seal member is a discontinuous body.

14. A method for fabricating a liquid crystal display panel, comprising:
forming a first seal member on a first substrate, thereby defining a space for accommodating a liquid crystal layer;
forming a second seal member on the first substrate or on a second substrate, the second seal member being configured to enclose the first seal member and being spaced a distance therefrom;
filling a liquid crystal layer into the space;
combining the first substrate and the second substrate together; and
curing the first seal member and the second seal member.

15. The method as recited in claim 14, wherein the each of the seal members comprises spacers incorporated in an ultraviolet cured sealing material or a thermosetting sealing material, a proportion of the spacers being in the range from 0.5 wt % to 2 wt %.

16. The method as recited in claim 14, wherein the liquid crystal layer is filled into the space by a one-drop-fill method.

17. The method as recited in claim 14, further comprising the step of distributing spacers in the liquid crystal layer.

18. The method as recited in claim 14, wherein the first substrate and the second substrate are combined together in a vacuum.

19. The method as recited in claim 14, wherein the first seal member is deposited or printed on the first substrate, and the second seal member is deposited or printed on the first substrate or on the second substrate.

20. An LCD (liquid crystal display) panel assembly, comprising:
a first substrate;
a second substrate spaced apart from the first substrate;
a first seal member interconnecting the first substrate and the second substrate, and defining a cell area therebetween;
a liquid crystal layer accommodated in the cell area; and
a second seal member located between the first substrate and the second substrate, and spatially located on an exterior side of the first seal member opposite to the liquid crystal layer for not only reinforcing the whole assembly but also blocking the first seal member from radially outwardly communicating with an exterior within at least a range of radial directions between 0 degree to 360 degrees.
